(19) United States
(12) Patent Application Publication
(10) Pub. No.: US 2020/0083573 A1
(43) Pub. Date: Mar. 12, 2020

(54) BATTERY ELECTRIC VEHICLE WITH COOLING CHANNELS INTEGRATED INTO FRONTAL IMPACT ABSORBING STRUCTURES

(71) Applicant: FORD GLOBAL TECHNOLOGIES, LLC, Dearborn, MI (US)

(72) Inventors: Ari Garo CALISKAN, Canton, MI (US); Peter A. FRIEDMAN, Ann Arbor, MI (US); Arnold KADIU, Dearborn, MI (US)

(21) Appl. No.: 16/129,127

(22) Filed: Sep. 12, 2018

(51) Int. Cl. H01M 10/613; B60K 1/04; H01M 2/10; B62D 25/20; B62D 21/15; B60L 3/00; H01M 10/625; H01M 10/656

(52) U.S. Cl. CPC H01M 10/613; B60K 1/04; H01M 2/1072; B62D 25/20; H01M 2220/20; B60L 3/0007; H01M 10/625; H01M 10/656; B60K 2001/0411; B62D 21/152

(57) ABSTRACT

A battery assembly for a vehicle including a battery pack and a platform supporting the battery pack. A tubular sled runner is longitudinally oriented to absorb collision forces in a frontal collision. The sled runner defines first and second coolant supply channels on opposite lateral sides of a central coolant return channel. A coolant circulation system provides coolant to the first and second coolant supply channels and receives coolant from the central coolant return channel. A coolant loop is disclosed for cooling another heat source with the coolant flowing through the sled runner. Longitudinally extending ribs may be provided on the inner side, outer side, or both sides of the sidewalls of the sled runner to increase crush resistance or heat transfer efficiency.

### TECHNICAL FIELD

This disclosure is directed to a battery containment system for a battery electric vehicle that has longitudinally extending rails for absorbing frontal impact collision forces. The longitudinally extending rails also include longitudinally extending channels for the circulation of coolant for cooling battery cells.

### BACKGROUND

A Battery Electric Vehicle (BEV) retains a traction motor battery in a container that is assembled to a platform attached to the frame of the vehicle. One type of architectural configurations for battery platforms for BEVs is commonly referred to as a “skateboard design.” Skateboard battery platforms allow major structural components such as the traction motor, battery packs, and electronic components to be accommodated on the battery platform. Coolant hoses and fittings are also assembled to the battery platform that add weight to the battery platform.

Maximizing battery volume while minimizing weight is paramount because range is a major priority in the design and manufacture of BEVs. Larger batteries are provided to increase range, but require more time to charge. BEVs having faster charging rates (225 Kw Future vs 50 Kw today) create more heat during charging that must be removed from the battery pack.

Battery platforms include reinforcement structures, such as beams and braces that are required to protect the battery in frontal collisions. The reinforcement structures add weight to the battery platform and generally do not provide any other function apart from reinforcing the battery platform.

This disclosure is directed to solving the above problems and other problems as summarized below.

### SUMMARY

According to one aspect of this disclosure, a battery assembly for a vehicle is disclosed that includes a battery pack and a platform supporting the battery pack. At least one tube extends longitudinally in the vehicle and is oriented to absorb collision forces in a frontal collision. The tube defines first and second coolant supply channels on opposite lateral sides of a central coolant return channel. A coolant circulation system provides coolant to the first and second coolant supply channels and receives coolant from the central coolant return channel.

According to another aspect of this disclosure, the battery pack may include a plurality of cells and may further comprise a plurality of cooling fins assembled to the tube adjacent the first and second coolant supply channels, the cooling fins are disposed between a pair of the cells to absorb heat from the cells and transfer the heat to the first and second coolant supply channels.

The tube may have a port end and a return end and the tube may define openings at the return end between each of the first and second coolant supply channels and the central coolant return channel.

The battery assembly may further comprise a first cap attached to a first end of the tube that includes first and second inlet ports opening into the first and second coolant supply channels and an outlet port opening into the central coolant return channel. A second cap closes a second end of the tube and at least partially defines pathways between the first and second coolant supply channels and the central coolant return channel.

The battery assembly may further comprise a coolant loop operatively connected to the coolant circulation system to receive coolant from the first and second coolant supply channels. The coolant loop may be adapted to cool a heat source apparatus and return the coolant through the central coolant return channel.

The heat source apparatus may be a motor and the tube may be an aluminum extrusion.

The tube includes sidewalls and inner walls that define the first and second coolant supply channels on opposite lateral sides of a central coolant return channel. The sidewalls may be extruded with ribs extending longitudinally on the inside or outside of the sidewalls. The ribs may function to increase the surface area of the side of the sidewall thereby improving heat transfer. The ribs may also be provided to increase the crush strength of the sidewall to adjust the collision impact absorption ability of the tube, or sled runner. Crush strength and heat transfer efficiency may be increased or decreased by changing the thickness of the inner walls and the sidewalls.

The battery assembly may further comprise a second tube extending in a longitudinal vehicle direction that is oriented to absorb collision forces in a frontal collision. The second tube may define third and fourth coolant supply channels on opposite sides of a second central coolant return channel. The coolant circulation system provides coolant to the third and fourth coolant supply channels and may receive coolant from the second central coolant return channel.

According to another aspect of this disclosure, a battery platform is disclosed that comprises a floor and a sled runner. The sled runner includes longitudinally extending walls that are attached to the floor to reinforce the battery platform against frontal impacts. The walls define two outer channels and an inner channel. The outer channels circulate coolant from a heat exchanger to the outer channels to absorb heat, and the inner channel circulates coolant from the outer channels to the heat exchanger.

According to another aspect of this disclosure, a sled runner is disclosed for a battery platform. The sled runner includes a tube defining a pair of coolant inlet channels and a coolant outlet channel. The coolant inlet channels are adapted to absorb heat that is transferred to a coolant fluid circulating through the tube. The coolant flows from the pair of coolant inlet channels to the coolant outlet channel and out of the tube. The tube includes longitudinally extending walls that are oriented and configured to reinforce the battery platform against frontal impacts.

The above aspects of this disclosure and other aspects will be described below with reference to the attached drawings.

### BRIEF DESCRIPTION OF THE DRAWINGS

FIG. 1 is a top plan view of a battery assembly for a battery electric vehicle.

FIG. 2 is a top plan view of a sled runner of the battery assembly illustrated in FIG. 1.

FIG. 3 is a side elevation view of the sled runner of the battery assembly illustrated in FIG. 1.

FIG. 4 is a cross section taken along the line 4-4 in FIG. 2.

FIG. 5 is a cross section taken along the line 5-5 in FIG. 2.

FIG. 6 is a fragmentary perspective view of the sled runner of FIG. 1.

FIG. 7 is a fragmentary perspective view of a return end cap taken at the portion of FIG. 6 labelled FIG. 7.

FIG. 8 is a top plan view of an alternative embodiment of a sled runner including a partially diagrammatic portion showing a coolant loop for a motor and a heat exchanger.

FIG. 9 is a fragmentary cross section of an alternative embodiment of a sidewall having external and internal ribs.

FIG. 10 is a fragmentary cross section view of another alternative embodiment of a sidewall have external ribs and a planar inner surface.

FIG. 11 is a fragmentary cross section view of another alternative embodiment of a sidewall have external ribs with cooling fins attached to the outer surface of the sidewall that includes a ribbed fin base that conforms to the outer surface of the sidewall.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

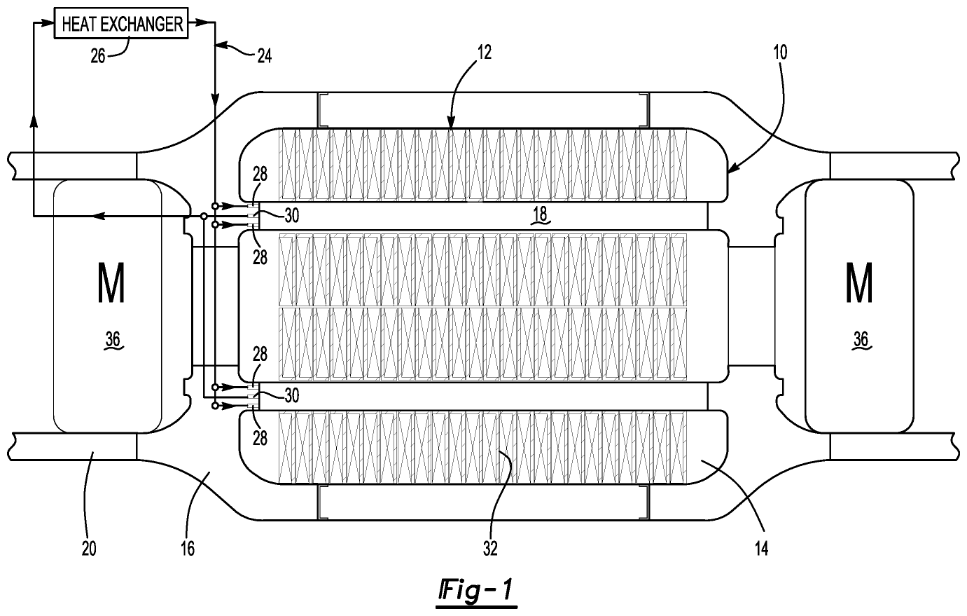

Referring to FIG. 1, a battery assembly is generally indicated by reference numeral 10 and is shown to include a plurality of battery packs 12, or battery cells. A platform 14, or floor, is part of the battery assembly 10 and supports the battery packs 12. The battery assembly 10 is attached to a frame 16 of the vehicle.

A sled runner 18, or longitudinally extending rigid tube, is assembled to the platform 14 and extends in the longitudinal vehicle direction. References to the longitudinal direction herein refer to the longitudinal vehicle direction, or fore-and-aft direction. Reference to the lateral direction herein, unless otherwise specified, refer to the cross-car direction. The body of the sled runner 18 is an elongated aluminum extrusion and is assembled to the platform 14 to extend in the longitudinal direction. One function of the sled runner 18 is to absorb impact forces from a front-end collision or rear-end collision. Reference numeral 20 indicates a forward, or front, area of the frame 16.

A coolant circulation system 24 is indicated diagrammatically in FIG. 1 and includes a pump for circulating coolant and a heat exchanger 26 such as a radiator. The coolant circulation system 24 is connected to the sled runner 18 by an inlet port 28 and an outlet port 30. A plurality of cooling fins 32 are assembled to the sled runners 18 and are inserted between adjacent battery cells 12 to absorb heat generated by charging and discharging the battery cells 12. The fins 32 include a fin base 34 that is assembled to the sled runners 18 to transfer the absorbed heat to the sled runners 18.

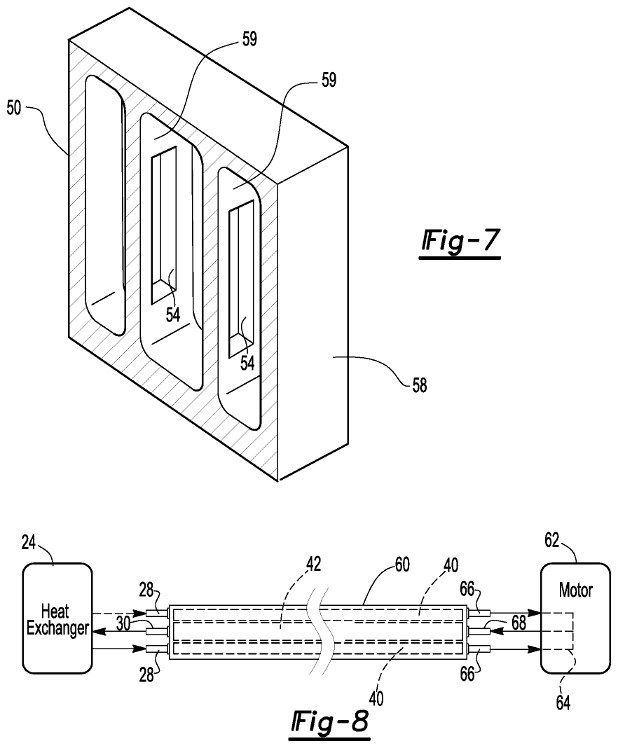

A front motor 36 and a rear motor 38 are shown diagrammatically in FIG. 1 that are used to propel the vehicle. A single motor or a plurality of motors may be used to move the vehicle. The coolant circulation system 24 is adapted to cool one or more motors 36, 38 as will be described below with reference to FIG. 7.

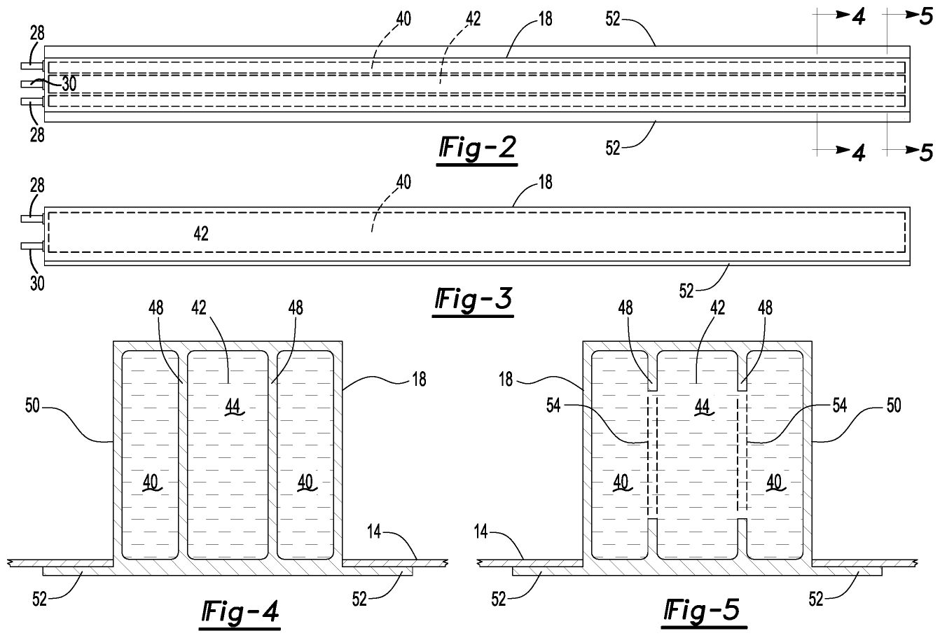

Referring to FIGS. 2-4, the sled runner 18 is illustrated in greater detail. The sled runner 18 defines two coolant supply channels 40 on opposite lateral sides of a coolant return channel 42. Coolant 44 is denoted by the dashed lines in FIG. 3. Inner walls 48 divide the space within the sled runners 18 longitudinally to form the two coolant supply channels 40 and the coolant return channel 42. The coolant supply channels 40 have an inner wall 48 on one side and a sidewall 42 on the opposite side. The two inner walls 40 are provided on opposite sides of the coolant return channel 42. As coolant 44 flows through the coolant supply channels 40, heat is absorbed and the coolant warms before flowing into the coolant return channel 42.

Referring to the embodiment shown in FIGS. 4 and 5, the sled runners 18 may also include base flanges 52 that are used to secure the sled runners 18 to the floor 14. As shown in FIGS. 3 and 4, the base flanges are attached to the lower surface of the floor 14. Alternatively, base flanges 52 could be attached to the upper surface of the floor 14.

In FIG. 2, the inlet ports 28 are shown that provide coolant 44 to the coolant supply channels 40. The outlet port 30 receives coolant 44 from the coolant return channel 42.

Referring to FIG. 4, the body of the sled runner 18 is shown in cross section with the inner walls 48 separating the coolant supply channels 40 from the coolant return channel 42. Coolant 44 is heated as it flows through the coolant supply channels 40 and into the coolant return channel 42.

In FIG. 5, the return end of the sled runner is shown in cross section. In one embodiment, the return end defines a passageway 54 in the inner walls 48. Coolant 44 flows from the two coolant supply channels 40 into the coolant return channel 42.

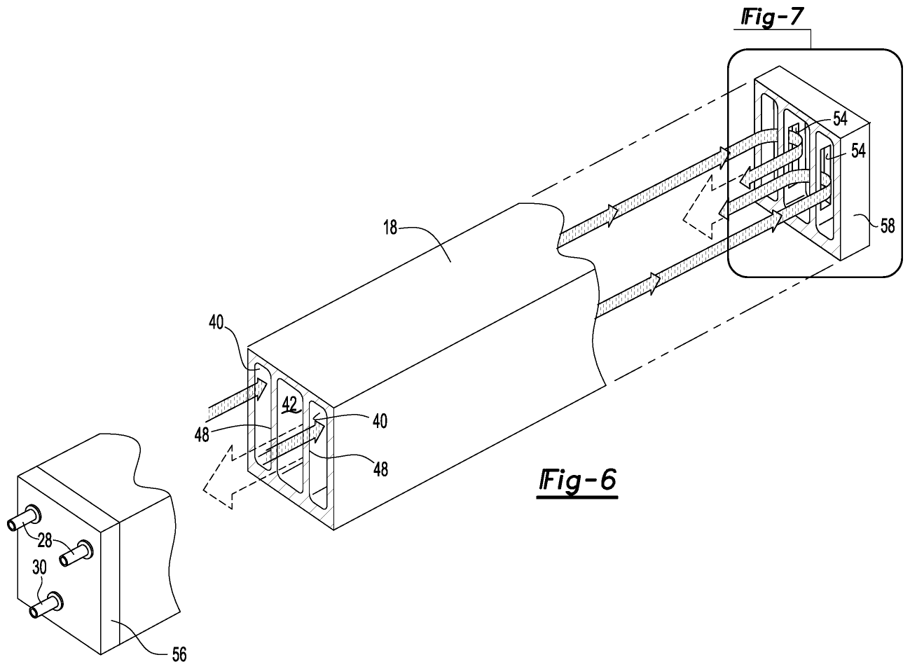

Referring to FIG. 6, in another embodiment, the sled runner 18 is shown to include a port end cap 56 and a return end cap 58. The inlet ports 28 and the outlet port 30 are attached to the port end cap 56. As illustrated, passageway 54 is provided through the inner walls 59 of the return end cap 58. In yet another embodiment, the inner walls 48 of the sled runner 18 may cut-away at the end and the return end cap 58 may define the passageways in conjunction with the inner walls 48.

In operation, the arrows illustrate the flow of coolant 44 through the sled runner 18. Coolant introduced through the inlet ports 28 flows into the coolant supply channels 40. As the coolant 44 flows through the coolant supply channels 40, heat collected by the cooling fins 32 (shown in FIG. 1) is drawn through the sidewalls 50. When the coolant 44 reaches the return end of the sled runner 18, after absorbing heat, the coolant 44 flows through the passageway 54 and into the coolant return channel 42. Coolant 44 flows in the reverse direction in the coolant return channel 42 relative to the fluid flow in the coolant supply channel 42 and is drained from the sled runner 18 through the outlet port 30 and is returned to the coolant circulation system.

FIG. 7 illustrates the embodiment of the return end cap 58 that has inner walls 59 defining the passageways 54. The inner walls 59 are aligned with the inner walls 48. In another embodiment, as previously described, the passageways 54 may be cut-away from the end of the body of the extruded sled runner 18 and the return end cap 58 may close off the return end.

Referring to FIG. 8, an alternative embodiment of a sled runner 60 is illustrated that may be used to provide cooling for a motor 62, or other heat source apparatus. Elements that are substantially like the embodiments shown in FIGS. 1-7 are identified by the same reference numerals in FIG. 8. The sled runner 60 provides the dual function of circulating the coolant 44 and absorbing the impact of a front-end collision or a rear-end collision. The inner walls 48 and outer walls 50 are aligned in the longitudinal direction to reinforce and resist compression of the battery assembly 10.

In operation, the coolant 44 is introduced through the inlet ports 28 and flows into the coolant supply channels 40. As the coolant 44 flows through the coolant supply channels 40, heat collected by the cooling fins 32 (shown in FIG. 1) is drawn through the sidewalls 50. When the coolant 44 reaches the end of the sled runner 18, the coolant 44 flows into the motor coolant loop 64 through the coolant outlet 66. The motor is cooled by the coolant flowing through the motor coolant loop 64 and is directed through the coolant return fitting 68 into the coolant return channel 42. The coolant 44 is drained from the sled runner 18 through the outlet port 30 and back to the coolant circulation system 24.

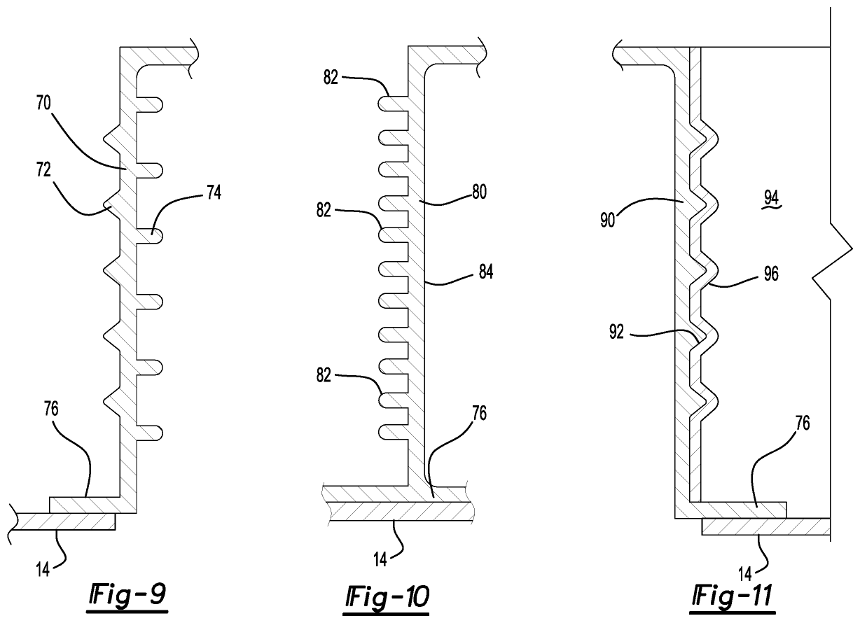

Referring to FIG. 9, a sidewall 70 is illustrated that includes external fins 72 that are provided to serve the dual purpose of increasing heat transfer through the sidewall 70. The external fins 72 are substantially triangular or V-shaped. Internal fins 74 are provided on the inner surface of the sidewall 70 to further increase the surface area for heat transfer and also add strength to increase the crush strength in the fore- and aft direction. The sidewall 70 includes a base flange 76 that is shown attached to the top surface of the floor 14.

Referring to FIG. 10, another alternative embodiment of a sidewall 80 is illustrated that includes a plurality of closely spaced external ribs 82. In the illustrated embodiment the sidewall 80 has a planar inner surface 84. The ribs 82 increase the surface area to improve heat transfer and strengthen the sidewall 80. The base flange is supported on the floor.

Referring to FIG. 11, another embodiment of a sidewall 90 is illustrated that includes a plurality of V-shaped ribs 92. A portion of a cooling fin 94 is shown to be attached to the sidewall 90. The fin 94 corresponds to the cooling ribs 32 shown in FIG. 1 but includes a ribbed fin base 96 that conforms to the contour of the sidewall 90 that includes the V-shaped ribs 92. Again, one function of the V-shaped ribs and ribbed fin base is to improve heat transfer from the batteries to the cooling fluid inside the coolant supply channel as previously described with reference to FIGS. 1-8. The V-shaped ribs also add strength. The ribs may alternatively be formed in other shapes such as semi-circular or rounded and are preferably formed as elongated shapes formed in the extrusion process used to manufacture the sled runner.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A battery assembly comprising:
a battery pack;
a platform supporting the battery pack;
a tube extending longitudinally and being oriented to absorb collision forces in a frontal collision, the tube defines first and second coolant supply channels on opposite lateral sides of a central coolant return channel; and
a coolant circulation system providing coolant to the first and second coolant supply channels receives coolant from the central coolant return channel.

2. The battery assembly of claim 1 wherein the battery pack includes a plurality of cells and further comprises:
a plurality of cooling fins assembled to the tube adjacent the first and second coolant supply channels, wherein cooling fins are disposed between a pair of the cells to absorb heat from the cells and transfer the heat to the first and second coolant supply channels.

3. The battery assembly of claim 1 wherein the tube has a port end and a return end, wherein the tube defines openings at the return end between each of the first and second coolant supply channels and the central coolant return channel.

4. The battery assembly of claim 1 further comprising:
a first cap attached to a first end of the tube and including first and second inlet ports opening into the first and second coolant supply channels and an outlet port opening into the central coolant return channel; and
a second cap closing a second end of the tube and partially defining at least one pathway between the first and second coolant supply channels and the central coolant return channel.

5. The battery assembly of claim 1 further comprising:
a coolant loop operatively connected to the coolant circulation system to receive coolant from the first and second coolant supply channels, wherein the coolant loop is adapted to cool a heat source apparatus and return the coolant through the central coolant return channel.

6. The battery assembly of claim 5 wherein the heat source apparatus is a motor.

7. The battery assembly of claim 1 wherein the tube has at least one side wall that includes a plurality of longitudinally extending ribs on at least one side of the at least one sidewall.

8. The battery assembly of claim 1 further comprising:
a second tube extending in a longitudinal vehicle direction and being oriented to absorb collision forces in a frontal collision, the second tube defining third and fourth coolant supply channels on opposite sides of a second central coolant return channel, wherein the coolant circulation system provides coolant to the third and fourth coolant supply channels and receives coolant from the second central coolant return channel.

9. A battery platform comprising:
a floor; and
a sled runner having longitudinally extending walls attached to the floor that reinforce the battery platform against frontal impacts, the walls defining two outer channels and an inner channel, wherein the outer channels circulate coolant from a heat exchanger to the outer channels to absorb heat, and wherein the inner channel circulates coolant from the outer channels to the heat exchanger.

10. The battery platform of claim 9 wherein the sled runner has a port end and a return end, wherein the sled runner defines openings at the return end between the two outer channels and the inner channel.

11. The battery platform of claim 9 further comprising:
a first cap attached to a first end of the sled runner and including first and second inlet ports opening into the two outer channels and an outlet port opening into the inner channel; and
a second cap closing a second end of the sled runner and at least partially defining a pathway between the two outer channels and the inner channel.

12. The battery platform of claim 9 further comprising:
a coolant loop operatively connected to the two outer channels and the inner channel, wherein the coolant loop is adapted to receive coolant from the two outer channels to cool a motor and return the coolant through the inner channel.

13. The battery platform of claim 9 the tube is an aluminum extrusion having at least one side wall that includes a plurality of longitudinally extending ribs on at least one side of the at least one sidewall.

14. The battery platform of claim 13 wherein the ribs formed on the at least one sidewall are V-shaped ribs that increase surface area of an outer side of the sidewall and that also increase crush resistance of the sled runner.

15. The battery platform of claim 9 further comprising:
a second sled runner having walls attached to the floor that reinforce the battery platform against frontal impacts, the second sled runner defining third and fourth outer channels on opposite sides of a second central coolant return channel, wherein the third and fourth outer channels circulate coolant from the heat exchanger to the second central coolant return channel that return the coolant to the heat exchanger.

16. A sled runner for a battery platform comprising:
a tube defining a pair of coolant inlet channels and a coolant outlet channel, the coolant inlet channels are adapted to absorb heat that is transferred to a coolant fluid circulating through the tube, coolant flows from the pair of coolant inlet channels to the coolant outlet channel and drains from the tube, the tube includes longitudinally extending walls that reinforce the battery platform against frontal impacts.

17. The sled runner of claim 16 wherein the sled runner has a port end and a return end, and wherein the sled runner defines openings at the return end between the pair of coolant inlet channels and the coolant outlet channel.

18. The sled runner of claim 16 further comprising:
a first cap attached to a first end of the tube and including first and second inlet ports opening into the pair of coolant inlet channels and an outlet port opening into the coolant outlet channel; and
a second cap closes a second end of the tube and at least partially defines pathways between the pair of coolant inlet channels and the coolant outlet channel.

19. The sled runner of claim 16 wherein the tube is an aluminum extrusion having at least one side wall that includes a plurality of longitudinally extending ribs on at least one side of the tube.

20. The sled runner of claim 19 wherein the plurality of longitudinally extending ribs formed on the tube are spaced fin-shaped ribs that increase surface area of the of the at least one sidewall and that also increase crush resistance of the sled runner.
